(19) United States
(12) Patent Application Publication
(10) Pub. No.: US 2015/0180288 A1
(43) Pub. Date: Jun. 25, 2015

(54) OPTIMIZED SYNCHRONOUS GENERATOR OF A GEARLESS WIND POWER PLANT

(71) Applicant: Wobben Properties GmbH, Aurich (DE)

(72) Inventors: Jochen Röer, Ganderkesee (DE); Wilko Gudewer, Norden (DE)

(73) Assignee: Wobben Properties GmbH, Aurich (DE)

(21) Appl. No.: 14/402,597

(22) PCT Filed: May 22, 2013
(86) PCT No.: PCT/EP2013/060479

§ 371 Date: Nov. 20, 2014

(30) Foreign Application Priority Data
May 22, 2012 (DE) 10 2012 208 549.1

(51) Int. Cl. H02K 1/06; H02K 9/04; H02K 7/08; F03D 9/00; H02K 9/02

(52) U.S. Cl. CPC H02K 1/06; F03D 9/002; H02K 9/02; H02K 7/083; H02K 9/04

(57) ABSTRACT

The invention relates to a synchronous generator of a gearless wind power plant, comprising an external rotor and a Stator, wherein the synchronous generator has a generator outside diameter and the Stator has a Stator outside diameter, and a ratio of the stator outside diameter to the generator outside diameter is greater than 0.86, in particular greater than 0.9, and in particular greater than 0.92.

### BACKGROUND

1. Technical Field

The invention concerns a synchronous generator of a gearless wind power installation. The invention also concerns a gearless wind power installation.

2. Description of the Related Art

Wind power installations are generally known, they generate electric energy from the energy of the wind. Usually a so-called horizontal-axis wind power installation is used for that purpose, as shown for example in FIG. 1. It has an aerodynamic rotor which, driven by the wind, rotates about a substantially horizontal axis and in so doing drives a generator. Particularly reliable wind power installations are of a gearless design so that the aerodynamic rotor is coupled directly to the generator, namely the electrodynamic rotor of the generator. The aerodynamic rotor and the electrodynamic rotor which for the avoidance of misunderstanding is referred to hereinafter as the rotor member rotate in that case at the same speed. For that purpose, at any event for wind power installations involving high levels of power which nowadays are in the megawatt range, corresponding synchronous generators of a large structural configuration, namely in particular with a large air gap diameter, are required. In other words, an air gap diameter is correspondingly greater and thus the structural configuration of the synchronous generator overall is correspondingly greater, the greater the amount of power that the synchronous generator is to generate.

The size of a generator however cannot be increased just as desired. In particular, transport conditions on public roads limit the structural size of a generator.

The wind power installation which at the present time is the most powerful in the world, the E126 from ENERCON GmbH, has an air gap diameter of 10 m and solves the transport problem in that both the rotor member and also the stator of the generator are respectively subdivided into four segments which are assembled only at or in the proximity of the location for erection of the wind power installation. Such a procedure however can be complicated and expensive and presupposes particular precautions in order to reduce risks of error, in particular at a separation location. It would also be desirable to reduce the complication and expenditure involved in assembly.

The German Patent and Trade Mark Office searched the following state of the art in the priority application: DE 44 02 184 A1, DE 196 36 591 A1, DE 199 23 925 A1 and DE 10 2004 018 758 A1.

### BRIEF SUMMARY

One or more embodiments of the present invention may address one or more of the above-mentioned problems. In particular in one embodiment there is provided a generator for a gearless wind power installation, which can be transported with as few problems as possible and which can be installed at the lowest possible level of complication and expenditure when erecting a wind power installation. The invention seeks to propose at least an alternative solution.

According to one embodiment of the invention there is proposed a synchronous generator of a gearless wind power installation includes an external rotor member and a stator around which the external rotor member rotates as desired. The synchronous generator has a generator outside diameter and the stator has a stator outside diameter. It is proposed that the synchronous generator is so constructed that a ratio of the stator outside diameter to the generator outside diameter is greater than 0.86. It is thus proposed that the air gap of a synchronous generator for a gearless wind power installation is disposed as far outwardly as possible. The synchronous generator is therefore correspondingly constructed such that the air gap is disposed as far outwardly as possible and accordingly the external rotor member is as narrow as possible so that said ratio of the stator outside diameter to the generator outside diameter is more than 0.86.

It is to be noted in that respect that, in a synchronous generator of the external rotor member type which is proposed here, the stator outside diameter basically corresponds to the air gap diameter. In this respect, the basic configuration adopted is in principle a cylindrical configuration both for the stator and also the rotor member and in particular the air gap. Disregarding the thickness of the air gap, the air gap diameter corresponds to the stator outside diameter.

Particularly preferably the air gap is displaced outwardly to such an extent that the ratio of the stator outside diameter to the generator outside diameter is greater than 0.9. Still more preferably the synchronous generator is so constructed that the ratio of the stator outside diameter to the generator outside diameter is greater than 0.92.

The proposed use of an external rotor member already permits such an advantageous ratio. Due to the construction involved more specifically the rotor member poles or in their actual physical configuration the rotor member pole shoes with the corresponding exciter windings if an externally excited synchronous generator is used can be reduced in their radial extent to a very small amount. As a result it is possible for the air gap to be displaced outwardly as far as possible. At the same time this means that the stator has room in order to advantageously design the stator windings. Further space in the interior of the stator can be used, as will also be described hereinafter in respect of some embodiments by way of example.

In an embodiment it is proposed that the stator has a radial support structure which extends radially inwardly and is adapted for fixing to an axle mounting extending axially through the stator. Thus the space in the interior of the stator is advantageously used for a stable structure for the stator. In that respect, the underlying construction involves an axle journal mounting which upon appropriate installation of the generator extends centrally through the stator. Such an axle mounting is a stable, in particular tubular element which is fixedly secured in a machine carrier and can be for example a ferrous casting. The support structure thus extends from the stator lamination assembly carrying the stator winding substantially from the air gap radially inwardly to that axle mounting on which it can be fixedly secured with a suitable annular flange.

It is preferably proposed that the stator has radial and axial cooling passages. The radial cooling passages are provided for radially supplying cooling air to the stator, namely in particular to the lamination assembly of the stator. The axial cooling passages then guide the radially supplied cooling air for cooling the stator along the latter, in particular through the stator lamination assembly and/or between rotor member poles. In particular the cooling air which is radially supplied in an adequate amount is divided for axially guiding same, namely in an axial forward direction which in proper operation of the wind power installation is in opposite relationship to the wind, and in a rearward direction, that is to say basically in the direction of the wind.

That also provides that the space in the interior of the stator is put to advantageous use. In that respect the use of that space permits a supply of a large volume of cooling air. If it is then divided in a forward direction and a rearward direction it appropriately flows from such a division location only over half the stator length, relative to the axial direction. Accordingly the stator can be well cooled and have long cooling paths, in respect of which cooling air, when reaching the end of such a cooling path, has already heated up to such an extent that its cooling capability is considerably reduced, are avoided.

It is also desirable for cooling air to be supplied radially over the entire axial extent of the stator. The radial cooling passages are thus of a width corresponding to the length of the stator. That permits the option of a large-volume cooling flow when the cooling air is supplied radially, and this avoids cooling air flow losses.

It is also desirable for the radial support structure to be so designed that it provides the radial cooling passages. In that way it is possible in principle to use the entire space within the stator for the supply of cooling air. For that purpose the support structure can have a few substantially radially extending support plates. Preferably plates are used, of which some extend radially and axially and others extend radially and transversely relative to a longitudinal axis, namely the axis of rotation of the synchronous generator. Those plate can be so assembled that they can reliably carry the stator, namely in particular the stator lamination assembly, and at the same time guide cooling air radially in the direction towards the stator lamination assembly. If the structure overall is so designed that the internal space in the stator is substantially available for that radial supply of cooling air, it is possible to guarantee a large-volume cooling air flow which in return achieves a low cooling air flow speed and accordingly makes only low demands in respect of the aerodynamics of the radial cooling passages.

According to a further configuration it is proposed that the synchronous generator is encapsulated. In particular it is proposed that the external rotor member of the synchronous generator is encapsulated. That makes it possible to achieve a compact structure which is also advantageous for handling for transport purposes. An advantageous structure such that the air gap is displaced radially outwardly as far as possible makes it possible to achieve an increase in generator power without an increase in outside dimensions. An increase in power is thus possible without increasing the overall dimension of the generator so that as far as possible the generator can be transported in one piece from a production factory to the erection location. An encapsulated construction can thus already be achieved in the factory and the generator can advantageously be transported in encapsulated fashion. That overall facilitates construction of the installation.

In particular for that purpose the rotor member, namely the external rotor member, can have a rotor member bell which more specifically encloses the rotor member in the fashion of a bell or as a cover. In that respect, inspection openings are provided in the bell for maintenance of the synchronous generator. Such inspection openings are openings which in particular can also be opened at an end of the rotor member bell to view the condition of the synchronous generator and possibly also to carry out minor repairs or the like.

Preferably the synchronous generator is separately excited. Thus the rotor member, namely the external rotor member, has many rotor member poles with exciter windings, by which a current for exciting the rotor member poles and thus the rotor member is controlled. Those rotor member poles are in particular in the form of pole shoes or pole shoe bodies with an exciter winding, which are carried at a support ring of the rotor member. That structure is thus so adapted in construction that it is particularly slender and is thus of a minimum possible thickness in the radial direction. As a result the air gap can be displaced radially outwardly as far as possible.

Preferably the synchronous generator is in the form of a ring generator. A ring generator describes a structural form of a generator, in which the magnetically effective region is arranged substantially on a ring region concentrically around the axis of rotation of the generator. In particular the magnetically effective region, more specifically of the rotor member and the stator, is arranged only in the radially outer quarter of the generator. That configuration in the form of a ring generator also provides a possibility of the air gap being displaced radially as far outwardly as possible or it simplifies attaining such a structure.

Preferably there is proposed a slowly operating synchronous generator which has at least 48 stator poles. Thus, even with a low speed of rotation, it is possible to generate an alternating current at a comparatively high frequency. Accordingly it is preferably proposed that there are provided at least 72 stator poles, wherein still more preferably even more stator poles are used, in particular at least 192 stator poles.

It is also desirable for the synchronous generator to be in the form of a 6-phase generator, more specifically a generator having two 3-phase systems which in particular are displaced relative to each other through about 30 degrees. Such a configuration is particularly advantageous for generating a 6-phase current which as a result is highly suited to rectification and due to the principle involved already causes a lesser degree of harmonics upon rectification.

It is further proposed that a continuous winding be provided for the stator, more specifically in particular a continuous line or a continuous line system for each phase. In the case of the 6-phase generator, that is to say with twice 3-phases therefore a total of six line systems would be implemented. The placement of such six line systems without interruption for the entire stator which can preferably be of an outside diameter of 4.5 m is extremely complicated and expensive but leads to a highly reliable stator and thus also a correspondingly reliable generator because this dispenses with connecting locations which could otherwise come loose in operation.

In a further embodiment it is proposed that the stator is carried on an axial mounting, in particular on an axle journal mounting. That axial mounting, in particular the axle journal mounting, extends axially through the stator and the external rotor member, more specifically centrally along the axis of rotation of the external rotor member and thus at the same time the central axis of the stator. In addition the external rotor member is preferably supported on a first and a second bearing connected to that mounting, wherein both bearings are arranged in the axial direction at one side of the stator, in particular in such a way that the one bearing is arranged in the axial direction between the other bearing and the stator. The rotor member is thus carried by those two bearings so that it is held in cantilever relationship in the region of the stator.

In other words the stator is fixedly secured to the mounting by those two axially spaced bearings so that the external rotor member extends over the stator and is carried on one side of the stator on the two bearings. That therefore gives an extremely stable structure which in that respect is comparatively easy to build. The use of two bearings, namely both on one side of the stator, is particularly well suited for carrying tilting forces which could be applied in particular by a wind load on the rotor blades by way of a rotor hub towards the external rotor member. It is to be noted that one or both of the bearings can also be arranged spaced at a greater distance from a fixing of the stator on the mounting or an axle journal. A spacing which is as large as possible between the two bearings also enhances the capability of carrying tilting forces.

Preferably there is proposed a synchronous generator which is characterized in that there is provided at least one blower (309), in particular in the support structure of the stator, to blow air for cooling purposes radially outwardly through the stator lamination assembly (658). The air flow is thus deliberately directed outwardly and can firstly cool the stator.

In a further embodiment it is proposed that the external rotor member has cooling openings towards the air gap so that a part of the cooling air flows from the air gap (206) further outwardly through the external rotor member (304) and between rotor member poles, in particular rotor member pole shoes (32A), of the external rotor member, along exciter windings of the external rotor member in order thereby to cool the rotor member pole shoes, in particular their exciter windings.

Thus at least in accordance with a preferred embodiment, there is proposed a large slowly operating synchronous generator which has a separately excited rotor member. It is cooled in specifically targeted fashion by at least one blower in the support structure of its stator. In that case the cooling air is blown radially outwardly by the blower, that is to say it is urged outwardly, and thus firstly cools the stator, in particular the stator lamination assembly, through which the cooling air flows outwardly to the air gap. The cooling air thus flows further through the air gap and in so doing cools the stator and the external rotor member. In addition a part of the cooling air which in the meantime has already been at least somewhat heated flows outwardly through openings in the external rotor member. As a result the exciter windings of the external rotor member can be reached and cooled, which otherwise are not in direct contact with the air gap.

The structure of this gearless, separately excited, slowly operating generator in the form of an external rotor member means that it is also possible to achieve such cooling of the external rotor member. The external rotor member structure also provides in the region of the pole shoes of the rotor member an intermediate space which permits such cooling.

Preferably the synchronous generator is so designed and sized that the stator outside diameter is at least 4.4 m, preferably at least 4.5 m and in particular at least 4.6 m, in particular with a generator outside diameter of 5 m. There is thus proposed a synchronous generator which with an outside diameter of 5 m still permits transport on public roads and in that respect is of a stator outside diameter that is as large as possible and can thus afford a nominal power which is as great as possible.

In addition there is proposed a wind power installation having a synchronous generator according to at least one of the above-described embodiments.

### BRIEF DESCRIPTION OF THE SEVERAL VIEWS OF THE DRAWINGS

The invention will now be described by way of example hereinafter by means of embodiments with reference to the accompany Figures.

FIG. 1 shows a perspective view of a wind power installation,

FIG. 2 shows a side view in section of a generator of internal rotor member type,

FIG. 3 shows a side view in section of a generator of external rotor member type,

FIG. 4 shows a perspective view of a generator similar to FIG. 3,

FIG. 5 shows a further perspective view of a generator as shown in FIG. 4,

FIG. 6 shows a perspective view of a generator according to the invention in a further embodiment,

FIG. 7 shows a perspective sectional view of the FIG. 6 generator,

FIG. 8 shows another view of the FIG. 7 generator,

FIG. 9 shows a diagrammatic view on an enlarged scale of a portion of a generator,

FIG. 10 shows a diagrammatic view on an enlarged scale of a portion of a generator,

FIG. 11 diagrammatically shows a portion of a rotor of an external rotor member together with a portion of a rotor of an internal rotor member, and

FIG. 12 diagrammatically shows a sectional side view of a generator fixed to a support structure.

### DETAILED DESCRIPTION

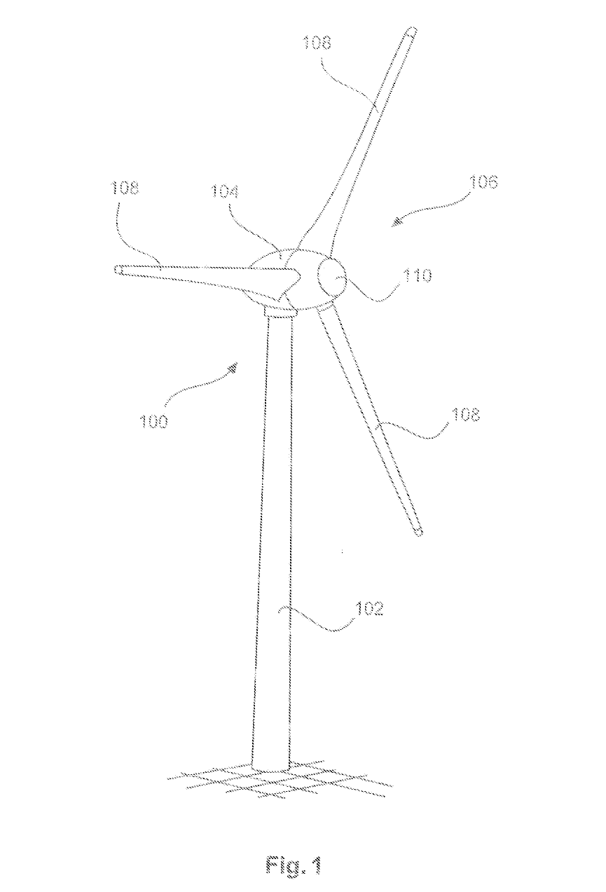

FIG. 1 shows a wind power installation 100 comprising a pylon 102 and a pod 104. Arranged at the pod 104 is a rotor 106 having three rotor blades 108 and a spinner 110. In operation the rotor 106 is caused to rotate by the wind and thereby drives a generator in the pod 104.

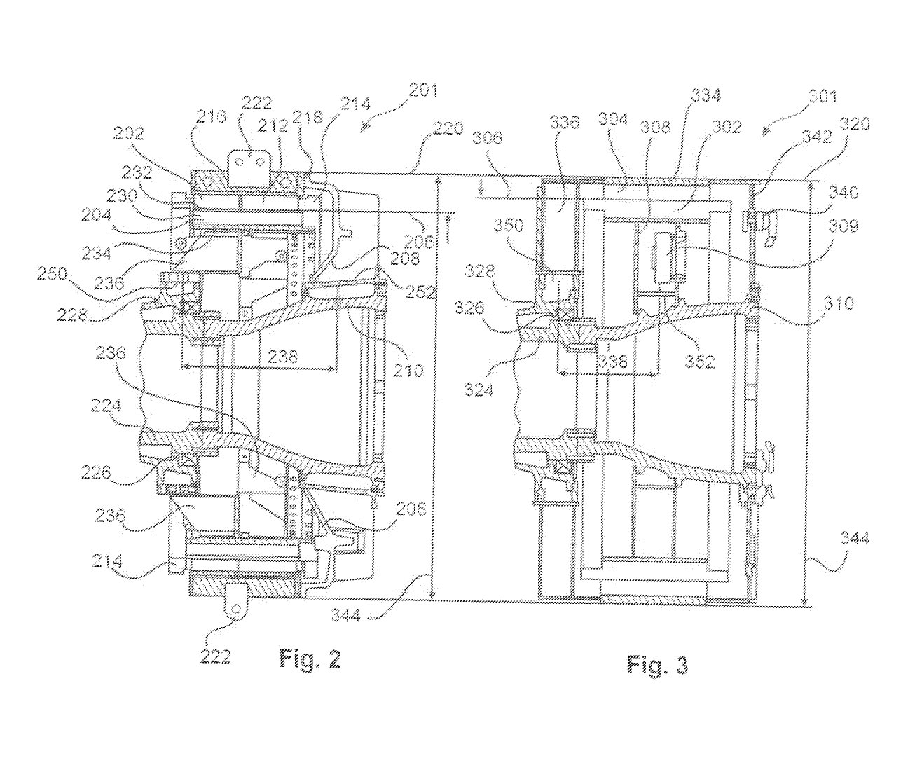

FIG. 2 shows a generator 201 of internal rotor member type and thus an externally disposed stator 202 and a rotor member 204 which is disposed inwardly in relation thereto. The air gap 206 is between the stator 202 and the rotor member 204. The stator 202 is carried on a stator carrier 210 by way of a stator bell 208. The stator 202 has stator lamination assemblies 212 which carry windings, of which winding heads 214 are shown. Basically the winding heads 214 show the winding wires which are laid from a stator groove into the next stator groove. The stator lamination assemblies 212 of the stator 202 are fixed to a support ring 216 which can also be viewed as part of the stator 202. The stator 202 is fixed to a stator flange 218 of the stator bell 208 by means of that support ring 216. The stator bell 208 carries the stator 202 by way thereof. In addition the stator bell 208 can provide blowers for cooling purposes, that are arranged in the stator bell 208. By virtue thereof air for cooling purposes can also be urged through the air gap 206 in order thereby to cool in the region of the air gap.

FIG. 2 also shows the outside periphery 220 of the generator 201. Only handling tongues 222 project therebeyond, which however does not cause any problem as they are not present over the entire periphery.

Adjoining the stator carrier 210 is an only partly shown axle journal 224. The rotor member 204 is supported on the axle journal 224 by way of two rotor member bearings 226 of which only one is shown. For that purpose the rotor member 204 is fixed to a hub portion 228 which is also connected to rotor blades of the aerodynamic rotor so that the rotor blades, moved by the wind, can rotate the rotor member 204 by way of that hub portion 228.

In this arrangement the rotor member 204 has pole shoe bodies with exciter windings 230. Towards the air gap 206, at the exciter windings 230, it is still possible to see a part of the pole shoe 232. To the side remote from the air gap 206, that is to say inwardly, the pole shoe 232 with the exciter winding that it carries is fixed to a rotor member support ring 234 which in turn is fixed to the hub portion 228 by means of a rotor member carrier 236. The rotor member support ring 234 is basically a continuous solid portion in the form of cylindrical configuration. The rotor member carrier 236 has a plurality of struts.

It will be seen from FIG. 2 that the radial extent of the rotor member 204, namely from the rotor member support ring 234 to the air gap 206, is markedly less than the radial extent of the stator 202, namely from the air gap 206 to the outer periphery 220.

In addition the Figure shows a spacing length 238 which approximately describes a mean spacing of a rotor member mounting 250 relative to a stator mounting 252. The length 238 is a dimension for influencing the air gap in the generator structure by virtue of external forces. With the generator shown in FIG. 2 that axial spacing length is comparatively great and thus shows that a very rigid construction of stator and rotor member is necessary in order to also ensure in operation a uniform spacing between the stator and the rotor member.

The generator 301 in FIG. 3 is of the external rotor member type. Accordingly the stator 302 is disposed inwardly and the rotor member 304 outwardly. The stator 302 is carried by a central stator support structure 308 on the stator carrier 310. A blower 309 is shown in the stator support structure 308 for cooling purposes. The stator 302 is thus centrally supported, which can greatly enhance stability. In addition it can be cooled from the interior by the blower 309 which only characteristically represents further blowers. In this construction the stator 302 is accessible from the interior. Cooling air is urged outwardly by the blower.

The rotor member 304 has an outwardly disposed rotor member support ring 334 which is fixed to a rotor member carrier 336 which can also be referred to as the rotor member bell 336 and is carried by the carrier or the bell on the hub portion 328 which in turn is mounted on an axle journal 324 by way of two rotor member bearings of which one rotor member bearing 326 is shown.

By virtue of the interchanged arrangement of the stator 302 and the rotor member 304 this configuration gives an air gap 306 which is of a larger diameter than the air gap 206 in FIG. 2 of the generator 201 of internal rotor member type.

FIG. 3 also shows an advantageous arrangement of a brake 340 which if required can stop the rotor member 304 by way of a brake disc 342 connected to the rotor member 304.

FIG. 3 also shows an axial spacing length 338 which also describes a mean spacing of the rotor member mounting 350 relative to a stator mounting 352. Here that length 338 is markedly reduced in comparison with the axial spacing length 238 shown in the generator of the internal rotor member type illustrated in FIG. 2. The axial spacing length 238 in FIG. 2 also determines a mean spacing between the two support structures for the stator 202 on the one hand and the rotor member 204 on the other hand. The shorter such an axial support length 238 or 338 respectively is, the correspondingly greater is the air gap stability which can be achieved, in particular also stability in respect of tilting between the stator and the rotor member.

The outside diameter 344 of the outer periphery 320 is identical in both the generators illustrated in FIGS. 2 and 3. The outer periphery 220 of the generator 201 in FIG. 2 thus also involves the outside diameter 344. In spite of the same outside diameter 344, the structure shown in FIG. 3 illustrating the generator 301 of the external rotor member type makes it possible to achieve a larger air gap diameter for the air gap 306 relative to the air gap 206 in FIG. 2.

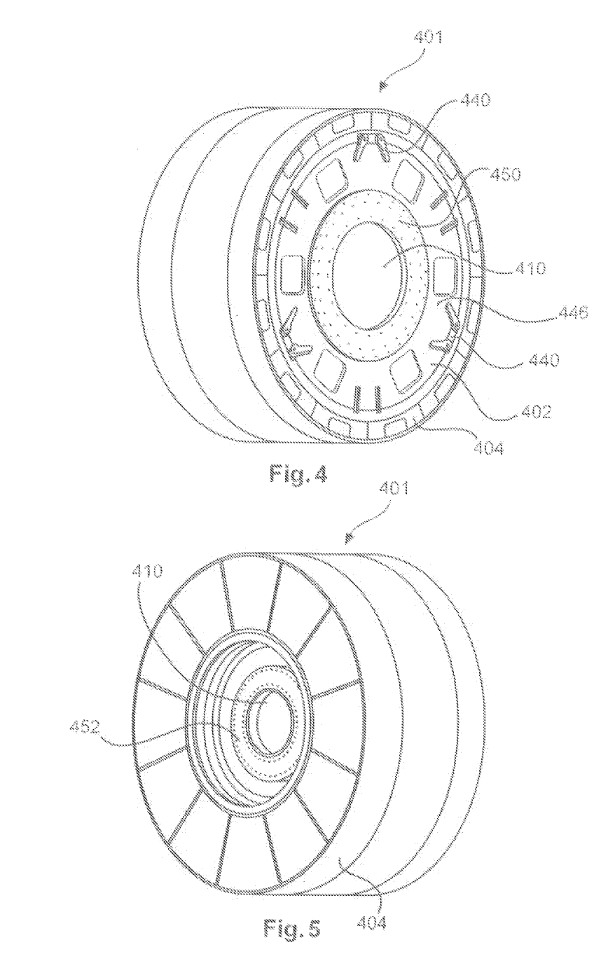

The basic structure of an encapsulated generator 401 according to one embodiment the invention can be seen from the perspective view in FIG. 4. FIG. 4 also shows a stator carrier 410, in particular its flange. That stator carrier 410 carries the stator. The illustrated carrier flange 450 is provided for fixing to a machine carrier which more specifically is fixedly arranged as required on a pod of a wind power installation. The stator carrier 410 carries the stator of the generator 401 and is also referred to as the axle journal mounting because that axle journal mounting is fixed with its one side, namely the carrier flange 450, to the machine carrier, while at its other side which is not shown in FIG. 4 it is fixedly connected to an axle journal. Such an axle journal carries or supports the aerodynamic rotor.

The stator carrier 410 or the axle journal mounting 410 can be interpreted as being part of the generator 401.

FIG. 4 also shows brakes 440 which also mark the transition from the external rotor member 404 to the inwardly disposed stator 402. In this case the brakes 440 are fixed to an annular stator disc 446 and from there can brake the rotor member 404 at its brake disc 442. The annular stator disc 446 is substantially fixed to the carrier flange 450.

FIG. 5 shows a further view of the generator 401 and essentially shows the encapsulated rotor member 404. In addition in the perspective view in FIG. 5, of the stator carrier 410 or the axle journal mounting 410, it is possible to see an axle journal flange 452 to which an axle journal is mounted in ordinary use. This also makes it clear that the axle journal mounting 410 or the stator carrier 410 can be interpreted as being part of the generator 401, which moreover applies not only for that embodiment, because it will be clearly seen from FIGS. 4 and 5 that the generator 401 with that stator carrier 410 does in any case form a spatially clearly predetermined arrangement.

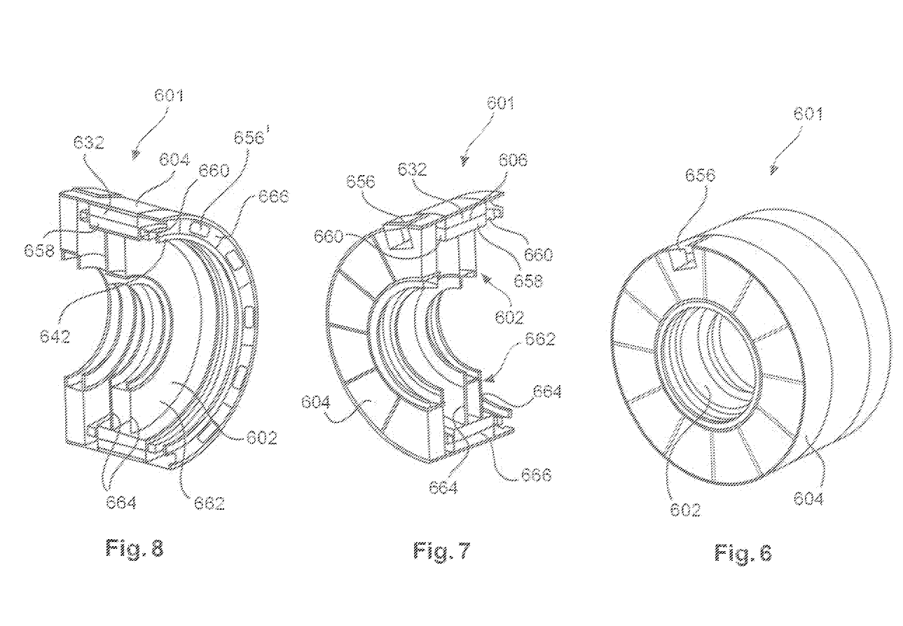

FIG. 6 shows a generator 601 which is of a similar structure to the generator 401 and the generator 301. The generator 601 differs from the generator 401 in FIGS. 4 and 5 substantially in that a stator carrier or an axle journal mounting is not shown, although this not an important consideration in terms of the view. In addition FIG. 6 shows an inspection opening 656 through which it is possible to look into the rotor member 604 to be able to perform any maintenance or checking operations on the rotor member 604. In addition the stator 602 can also be at least partially examined and assessed through that inspection opening 656. The inspection opening 656 is shown for illustrative purposes in FIG. 6. If required however and having regard to the remaining stability of the illustrated encapsulation of the rotor member 604 further inspection openings 656 are preferably also to be provided. For examining and assessing just the stator 602, one inspection opening 656 could suffice, which as required can be turned to the corresponding location of the stator 602. For examining the rotor member 604 however it may be advantageous to provide a plurality of such inspection openings 656.

The view in FIG. 7 shows a part of the structure of the inwardly disposed stator 602. It has a stator lamination assembly 658 which is wound thereon, as indicated by the winding heads 660. Towards the axis of rotation the stator 602 has a radial support structure 662. The radial support structure 662 substantially includes two radial guide plates which extend radially outwardly and in that respect are arranged perpendicularly to the axis of rotation of the generator 601. Those radial guide plates 664 can fix the stator 602, in particular the stator lamination assembly 658, with its windings, on a stator carrier or an axle journal mounting as shown for example in FIG. 4 and identified by reference 410. At the same time the guide plates 664 can pass air as cooling air to the stator lamination assembly 658.

In that way the stator lamination assembly 658 and also the windings therein, which are indicated by the winding heads 660, can be cooled. Radially outwardly adjoining the stator lamination assembly 658 is the rotor member 604 with its pole shoes 632. An air gap 606 is provided between the stator lamination assembly 658 and the pole shoes 632, the air gap being visible only as a line in FIG. 7.

The perspective view in FIG. 8 also illustrates the structure of the stator 602 with its radial support structure 662 with the two radial guide plates 664. In this respect it is possible to see further inspection openings 656′ which are also provided for assessing and maintaining both the stator 602 and also the rotor member 604. In that respect the inspection openings 656′ are arranged in a radial rotor plate 666 and allow a view on to the pole shoes 632 of the rotor member and in particular the winding heads 660 at the machine carrier side.

In that arrangement the radial rotor plate 666 is such that a brake disc 642 can also be carried.

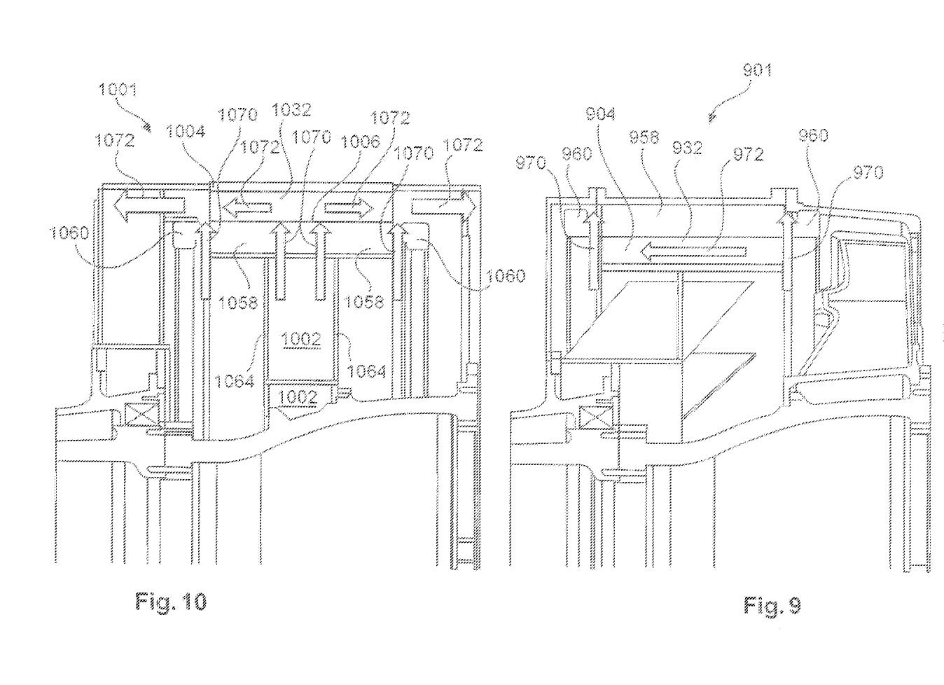

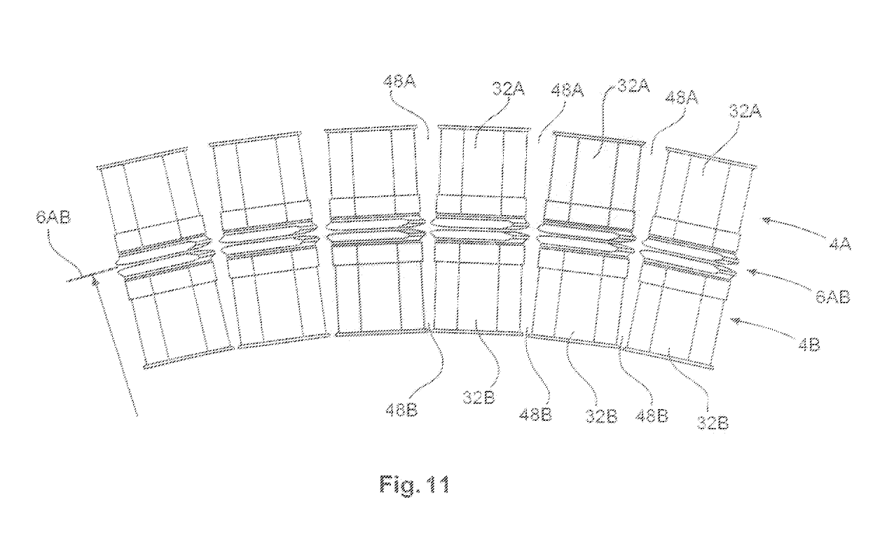

FIGS. 9 and 10 show a partial view illustrating cooling flows in different generator types, namely a generator 901 of the internal rotor member type in FIG. 9 and a generator 1001 of external rotor member type in FIG. 10. The portion in FIG. 9 approximately corresponds to the portion of a generator 201 as shown in FIG. 2, FIG. 9 showing a somewhat different embodiment. The portion in FIG. 10 approximately corresponds to the portion of a generator 301 as shown in FIG. 3, FIG. 10 showing a somewhat different embodiment.

Referring to FIG. 9 radial cooling flows 970 flow substantially on both sides—with respect to the view in FIG. 9 of the rotor 904 outwardly towards the stator lamination assembly 958 and the winding heads 960. An axial cooling flow 972 is formed only in one direction and thus has to completely cool in the axial direction both the stator lamination assembly 958 and also the rotor member pole shoes 932. The cooling path is therefore comparatively long and a feed of cooling air is effected substantially by way of one of the radial cooling flows 970.

The generator 1001 of external rotor member type guides cooling air radially to the stator lamination assembly 1058 by way of radial cooling flows 1070 basically over the full width of the stator 1002, and from the stator lamination assembly the cooling air is possibly further guided by way of cooling passages (not shown) to rotor member pole shoes 1032. The cooling air can cool the rotor member 1004 and the stator 1002 in two directions as an axial cooling flow 1072. Therefore a great deal of cooling air can be supplied, more specifically over the full width of the stator 1002—in relation to the view in FIG. 10—or over the full axial length of the stator 1002. In that case the radially supplied cooling air of the radial cooling flows 1070 can split up upon reaching approximately the air gap 1006 so that the stator 1002 and the rotor member 1004 only have to be respectively axially cooled by a cooling flow in respect of half thereof. The heating distance of the respective cooling flow is thus halved.

The comparison between FIGS. 9 and 10 also illustrates the position and the space requirement of the stator winding heads 960 of the generator 901 in FIG. 9 for the case of an internal rotor member and the stator winding heads 1060 of the generator 1001 in FIG. 10 for the external rotor member on the other hand.

The radial and axial cooling flows 1070 and 1072 shown in FIG. 10 can be produced for example by a blower like for example the blower 309 shown in the generator 301 in FIG. 3. Such a blower of which a plurality can also be provided can for example urge cooling air between the two radial guide plates 1064 so that cooling air is guided radially outwardly between the two radial guide plates 1064. In addition, a cooling flow can result in the radial direction, due to another feed of cooling air to the stator. When the cooling flow arrives at the stator lamination assembly 1058 or the pole shoes 1032 or substantially in the region of the air gap 1006 it can be diverted into an axial flow. Suitable cooling passages can be provided distributed over the stator lamination assembly 1058 for further passing radial cooling air 1070 through the stator 1002. Cooling air can flow substantially along between pole shoes 1032 in the axial direction and can also flow axially through the air gap 1006. A partly axial flow of cooling air is also possible in parts of the stator lamination assembly 1058, namely in particular in winding grooves, insofar as windings disposed therein have left a free space, for example by virtue of cooling passages, which are disposed in the windings. A further path of cooling air can be through passages which extend within the lamination assembly. Quite apart therefrom it is pointed out that the radial cooling flows 1070 and axial cooling flows 1072 indicated by arrows are to be interpreted as a diagrammatic view. A part of the cooling air can flow radially outwardly from the air gap 1006 through openings in the rotor member 1004, namely the external rotor member 1004, and can thereby better cool the external rotor member 1004, although those flow portions are not shown in FIG. 10.

FIG. 11 is a diagrammatic view showing in a portion of the structure pole shoes 32A of an external rotor member 4A together with pole shoes 32B of an internal rotor member 4B combined together in one view. In this assembly the illustrated arrangement is not part of a functioning machine.

Rather, FIG. 11 is intended to clearly illustrate the difference in the pole shoe arrangement of an external rotor member 4A of a separately excited synchronous generator relative to the pole shoe arrangement of an internal rotor member 4B of a synchronous generator. FIG. 11 also shows an air gap 6AB as an orientation guide. The internal rotor member 4B extends from the air gap 6AB inwardly, with the consequence that the pole shoes 32B converge from the air gap 6AB. In that case the intermediate spaces 48B decrease and the pole shoes 32B basically converge towards each other. This means that the winding space of the pole shoes 32B is restricted and also space for possible cooling flows is reduced. It is pointed out that FIG. 11 shows a view in the axial direction, that is to say viewing along the axis of rotation.

On the other hand the pole shoes 32A of the external rotor member 4A diverge radially outwardly from the air gap 6AB. Accordingly there is a great deal of intermediate space 48A between the pole shoes 32A. That effect can also be put to use structurally and it becomes possible for the radial extent of the rotor member pole shoes and thus basically the radial extent of the rotor member to be reduced. That represents a possible measure—in principle for the various embodiments—for the air gap to be placed as far outwardly as possible in order thereby to still further increase or optimize its efficiency, with a given structural size, in particular a given generator outside diameter.

The view of the external rotor member 4A in FIG. 11 shows the intermediate spaces 48A for which it is also proposed that they are used to guide cooling air.

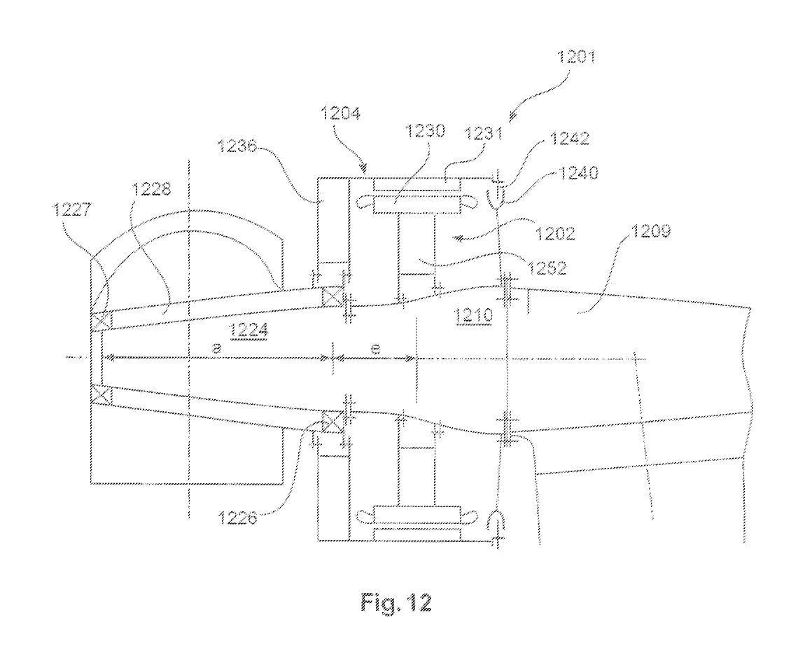

FIG. 12 diagrammatically shows a generator in an embodiment in an installed condition. Provided there is a machine carrier 1209 to which there is fixed a stator carrier 1210 to which an axle journal 1224 is in turn fixed. Of the generator 1201 the stator 1202 is fixed to the stator carrier 1210. The machine carrier 1209, the stator carrier 1210, the axle journal 1224 and the stator 1202 are thus connected to provide a rigid stationary element, apart from the possibility of azimuth adjustment of the entire illustrated structure.

The externally disposed rotor member 1204 is fixed to a rotor hub 1228 by way of a rotor carrier 1236. The hub portion 1228 is mounted rotatably on the axle journal 1224 by way of a first and a second rotor bearing 1226 and 1227 respectively. The large axial spacing between the first and second rotor bearings 1226 and 1227 affords a high level of tilting stability for the rotor member 1204.

The Figure also shows an axial spacing length e corresponding to the spacing length 338 in FIG. 3. This describes a mean spacing in the axial direction from the rotor carrier 1236 to a stator mounting 1252. By the provision of an external rotor member generator and thus an inwardly disposed stator 1202 the stator 1202, as viewed in the axial direction, can be fixedly secured centrally on the stator carrier 1210 so that the illustrated spacing length e is comparatively short. Together with the large spacing and the tilting stability resulting therefrom it is possible to achieve a particularly stable structure.

The rotor member 1204 also has a peripherally extending brake disc 1242 which in operation rotates together with the rotor member 1204. A brake 1240 is correspondingly provided for braking or arresting purposes.

It can also be seen from FIG. 12 that there is a great deal of space for cooling medium, in particular cooling air, to be caused to flow against the stator 1202 from the interior. Inter alia such a cooling medium can also flow within the illustrated stator mounting 1252 to the stator, in particular in the region of the stator windings 1230. In addition the radially guided cooling air can be used for cooling the rotor poles 1231 of the exciter winding.

In principle it is therefore possible, in comparison with a separately excited internal rotor member generator, to increase the air gap diameter with the same overall outside diameter. If, in the case of internal rotor member generators, the ratio of air gap diameter to overall outside diameter is limited to below a value of 0.86, it now becomes possible to increase that ratio even with a separately excited external rotor member. It is now possible to implement a ratio of 0.86 to 0.94. In addition, in an encapsulated design, there is sufficient space for the stator winding heads. In that respect this gives good accessibility to the stator winding heads, in the case of an encapsulated design configuration.

In the case of an external rotor member generator it is easily possible to provide for a through flow of air over the entire stator lamination assembly, with a supply of air within the outside dimensions.

With a separately excited external rotor member generator as is proposed, in comparison with an internal rotor member generator involving the same air gap diameter, it is possible to implement a larger lamination assembly in the poles, more exciter windings and more cooling air between the pole assemblies.

Disadvantages in the state of the art such as a small air gap diameter with comparable outside dimensions, difficult or practically impossible accessibility to the stator winding head in an encapsulated structure and limited air cooling options can be at least partially addressed by one or more embodiments of the proposed invention. It is thus possible to achieve better utilization of material, better cooling and accordingly a higher level of generator power or lower generator power loss.

At the same time the transport dimensions are kept small, in particular it is possible to observe maximum transport dimensions for transport on public roads. It is possible to achieve an improvement of cooling of the generator and accordingly a higher level of generator power or at least a low level of generator power loss can be achieved.

With a proposed separately excited external rotor member generator, in comparison with known internal rotor member generators involving the same air gap diameter, it is possible to achieve a larger lamination assembly, more exciter winding and more cooling air between the pole assemblies or poles.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A synchronous generator of a gearless wind power installation, the synchronous generator comprising:
an external rotor member; and
an internal stator, wherein the synchronous generator has a generator outside diameter and the stator has a stator outside diameter and a ratio of the stator outside diameter to the generator outside diameter is greater than 0.86.

2. The synchronous generator according to claim 1 wherein the stator has a radial support structure that extends radially inwardly and is adapted for fixing to an axle mounting extending axially through the stator.

3. The synchronous generator according to claim 1 wherein the stator includes:
radial cooling passages for radially supply cooling air from inside; and
axial cooling passages for axially guiding the radially supplied cooling air for cooling the stator in such a way that the radially supplied cooling air is passed through a stator lamination assembly and through stator winding assemblies, wherein the radially supplied cooling air is divided up and passed axially in a forward direction and in a rearward direction.

4. The synchronous generator according to claim 3 wherein the cooling air is supplied radially over an entire axial extent of the stator and the radial cooling passages are provided by a radial support structure.

5. The synchronous generator according to claim 1 wherein the external rotor member is encapsulated by a rotor member bell, the rotor member bell includes an inspection opening for maintenance of the external rotor member and the stator.

6. The synchronous generator according to claim 1 wherein the synchronous generator is separately excited and is a ring generator that has at least 48 stator poles, and the stator has a continuous winding.

7. The synchronous generator according to claim 1 wherein the stator is carried on an axial mounting extending through the stator and the external rotor member includes an axle journal mounting, and the external rotor member is supported on a first and second bearing connected to the mounting, wherein the first and second bearings are arranged in the axial direction at one side of the stator in such a way that the first bearing is arranged between the second bearing and the stator in the axial direction.

8. The synchronous generator according to claim 1 wherein the stator outside diameter is at least 4.5 m wherein the generator outside diameter is about 5 m.

9. The synchronous generator according to claim 1 further comprising at least one blower in the support structure of the stator, wherein the at least one blower is configured to blow air radially outwardly through the stator to cool the stator.

10. The synchronous generator according to claim 1 further comprising an air gap between the external rotor member and the stator, and the external rotor member has cooling openings towards the air gap so that a part of the cooling air flows from the air gap further outwardly through the external rotor member and between rotor member poles.

11. A wind power installation comprising:
a pylon;
a pod arranged on the pylon; and
a synchronous generator located in the pod, the synchronous generator including:
an external rotor member; and
an internal stator, where the synchronous generator has an overall outside diameter and the internal stator has a stator outside diameter and a ratio of the internal stator outside diameter to the generator outside diameter is greater than 0.86.

12. The wind power installation according to claim 11, wherein the ratio is between 0.86 and 0.92.

13. The wind power installation according to claim 11, further comprising an air gap between the external rotor member and the internal stator, and the external rotor member has cooling openings towards the air gap so that a part of the cooling air flows from the air gap further outwardly through the external rotor member and between rotor member poles.

14. The wind power installation according to claim 11 wherein the stator has a radial support structure that extends radially inwardly and is configured to be fixed to an axle mounting extending axially through the stator.

15. The wind power installation according to claim 11 wherein the stator includes a stator lamination assembly and stator winding assemblies, the stator further including:
radial cooling passages that are configured to radially supply cooling air from the inside; and
axial cooling passages that are configured to guide the radially supplied cooling air through the stator lamination assembly and through the stator winding assemblies, wherein the radially supplied cooling air is divided up and passed axially in a forward direction and in a rearward direction.

16. The synchronous generator according to claim 1 wherein the ratio of the stator outside diameter to the generator outside diameter is greater than 0.92.

17. The synchronous generator according to claim 10 wherein the cooling air flows from the air gap further outwardly through the external rotor member and between rotor member pole shoes of the external rotor member and along exciter windings of the external rotor member to cool the rotor member pole shoes and the exciter windings.
